(19) United States
(12) Patent Application Publication
(10) Pub. No.: US 2010/0268981 A1
(43) Pub. Date: Oct. 21, 2010

(54) System and Method for Tunneling System Error Handling Between Communications Systems

(75) Inventor: Zhixian Xiang, Plano, TX (US)

Correspondence Address: Slater & Matsil, L.L.P., 17950 Preston Road, Suite 1000, Dallas, TX, 75252, US

(73) Assignee: FutureWei Technologies, Inc., Plano, TX (US)

(21) Appl. No.: 12/763,020

(22) Filed: Apr. 19, 2010

Related U.S. Application Data
(60) Provisional application No. 61/171,001, filed on Apr. 20, 2009.

(51) Int. Cl. G06F 11/07

(52) U.S. Cl. 714/2; 714/48; 714/E11.023; 714/E11.025

(57) ABSTRACT

A system and method for tunneling system error handling between communications systems are provided. A method for error handling by a controller in an interworking system includes receiving a notification of an occurrence of an error in a first communications system, determining if the error is a long-term error, causing a device in a second communications system with a session in the first communications system to halt communications with the first communications system if the error is a long-term error, and not causing the device in the second communications system with the session in the first communications system to halt communications with the first communications system if the error is not a long-term error.

This application claims the benefit of U.S. Provisional Application No. 61/171,001, filed on Apr. 20, 2009, entitled “System and Method for Tunneling System Error Handling Between Wireless Communications Systems,” which application is hereby incorporated herein by reference.

### TECHNICAL FIELD

The present invention relates generally to wireless communications, and more particularly to a system and method for tunneling system error handling between communications systems.

### BACKGROUND

As communications systems continue to evolve and improve, it may be common for a service area to be served by multiple communications systems as service providers upgrade equipment while keeping older equipment operational for compatibility purposes. In order to maximize user equipment (UE) flexibility, the UE may be operable in the multiple communications systems. Such UEs may be referred to as hybrid devices.

FIG. 1 illustrates a prior art hybrid device 105 that is capable of operating in a Third Generation Partnership Project (3GPP) Long Term Evolution (LTE) compliant communications system (shown as coverage area 110 and controlled by a LTE enhanced NodeB (eNB) 112) and a High Rate Packet Data (HRPD) compliant communications system (shown as coverage area 115 controlled by a HRPD eNB 117).

Hybrid device 105 may be located outside of coverage area 115 of HRPD eNB 117 and therefore, may use tunneling to communicate with the HRPD communications system. Tunneling makes use of the LTE communications system to facilitate communications with the HRPD communications system. For example, hybrid device 105 may communicate with HRPD eNB 117 by creating a tunnel (shown as dashed line 120) to HRPD eNB 117 via LTE eNB 112 and attendant wired or wireless network infrastructure. An HRPD access network (AN) 125 may control access to the HRPD communication system.

As specified in the 3GPP Release 8 specifications for code-division multiple access (CDMA)/LTE interworking, a UE can interact with a CDMA communications system by the tunneling through an eNB of the LTE communications system. HRPD may be used to provide high-speed wireless data communications in a CDMA communications system. A mobility management entity (MME) 130 of the LTE communications system may be used for pre-registration, registration, and/or handover preparation, all while the UE is still camped on an LTE air-interface. But if there is serious system problem, i.e., a long-term error, in the CDMA communications system which causes the interaction to fail, there may not be a way for the eNB to be aware of the system problem. Rather, the impetus is solely on the UE to handle the situation.

Normally the UE can use its own retry mechanism to retry the pre-registration, registration procedure, or handover procedures, so if many UEs attempt the retry simultaneously, the retry mechanism of the UEs may cause a significant amount of transmission traffic, leading to a resource problem for the LTE communications system.

### SUMMARY

These problems and technical advantages are generally achieved, by embodiments of a system and method for tunneling system error handling between communications systems.

In accordance with an embodiment, a method for error handling by a controller in an interworking system is provided. The method includes receiving a notification of an occurrence of an error in a first communications system, determining if the error is a long-term error, causing a device in a second communications system with a session in the first communications system to halt communications with the first communications system if the error is a long-term error, and not causing the device in the second communications system with the session in the first communications system to halt communications with the first communications system if the error is not a long-term error.

In accordance with another embodiment, a method for error handling by a management controller in an interworking system is provided. The method includes receiving error information indicating that a long-term error has occurred in a first communications system, the error information received by a management controller of a second communications system, and causing a device in a second communications system with a connection to the first communications system to halt communications with the first communications system.

In accordance with another embodiment, a management controller is provided. The management controller includes a receiver to be coupled to a receive antenna, a transmitter to be coupled to a transmit antenna, a controller coupled to the receiver and to the transmitter, a mapping unit coupled to the controller, and a message generate unit coupled to the controller and to the transmitter. The receiver receives signals detected by the receive antenna, and the transmitter transmits signals with the transmit antenna. The controller propagates error information related to an error detected in a first communications system to a device in a second communications system having a connection to the first communications system, and the mapping unit maintains a mapping of the device to a controller in the second communications system serving the device. The message generate unit generates an error information message to be propagated to the device desiring to establish the connection with the first communications system.

An advantage of an embodiment is that long-term or permanent errors may be classified differently from short-term errors and may be handled in a manner than short-term errors. A detected long-term errors is handled so that a flood of transmissions and re-transmissions does not overwhelm a communications system, which may negatively impact the performance of the communications system.

A further advantage of an embodiment is that when a long-term error is detected, the behavior of communications devices is modified by information provided to the communications device from the communications system rather than allowing the communications devices to decide their own response to the long-term error.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 is a diagram of a prior art hybrid device that is capable of operating in a Third Generation Partnership Project (3GPP) Long Term Evolution (LTE) compliant communications system and a High Rate Packet Data (HRPD) compliant communications system;

FIG. 2 is a flow diagram of UE operations in a prior art tunneling system error handling technique;

FIG. 3a is a diagram of an AN;

FIG. 3b is a diagram of a MME;

FIG. 4a is a transmission flow diagram for messages exchanged after a long-term error has been detected in an interworking with an LTE communications system and a HRPD communications system;

FIG. 4b is a transmission flow diagram for messages exchanged after a long-term error has been resolved;

FIG. 5a is a flow diagram of HRPD AN operations in system error handling;

FIG. 5b is a flow diagram of MME operations in system error handling;

FIG. 5c is a flow diagram of eNB operations in system error handling;

FIG. 5d is a flow diagram of UE operations in system error handling;

FIG. 6a is a flow diagram of HRPD AN operations in system error handling after system error recovery;

FIG. 6b is a flow diagram of MME operations in system error handling after system error recovery;

FIG. 6c is a flow diagram of eNB operations in system error handling after system error recovery; and

FIG. 6d is a flow diagram of UE operations in system error handling after system error recovery.

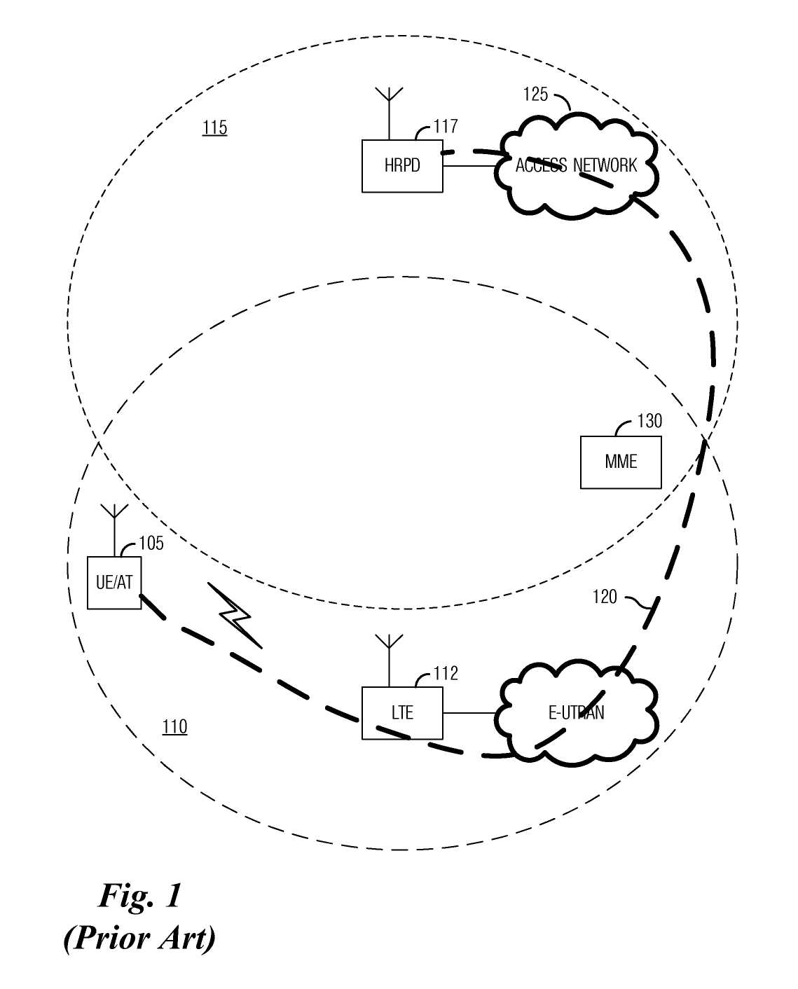

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely an interworking with a 3GPP LTE compliant communications system and a HRPD compliant communications system. The invention may also be applied, however, to interworking with other communications systems, such as 3GPP LTE-Advanced, enhanced HRPD, WiMAX, WiFi, and so forth, compliant communications systems.

According to Third Generation Partnership Project Two (3GPP2) Technical Standard TS29.276, a failure in an Evolved Packet System interface between a MME and a HRPD AN, wherein the evolved packet system interface is also known as “S101,” may include path failure and/or protocol error. In a LTE to HRPD pre-registration procedure, registration procedure, or handover preparation procedure, if the MME cannot restore a S101 failure to allow the pre-registration procedure or the handover preparation procedure to proceed, the pre-registration procedure, registration procedure, or the handover preparation procedure will fail.

For example, a ‘No Memory Available’ error may indicate that the MME or an HRPD AN does not have enough memory to execute the procedure, a ‘System Failure’ error may indicate that a generic permanent error condition has occurred, while an ‘Invalid Message Format,’ ‘Mandatory Information Element (IE) Incorrect,’ ‘Mandatory IE Missing,’ and ‘Optional IE Incorrect’ may indicate protocol errors, and a ‘Path Failure’ may indicate that the S101 connection is abnormal and information may not be transferred correctly. Typically, a System Failure or a Path Failure may indicate a long-term error condition, which may require a long time to service and restore, while the other failures may be short-term error conditions, which may be corrected in a short time.

If a long-term error condition (e.g., a System Failure or a Path Failure) occurs, a UE by design may attempt a specified number of retries by re-sending messages. For example, the UE may re-send messages to initiate the pre-registration procedure, registration procedure, or the handover preparation procedure. These messages may consume valuable network resources.

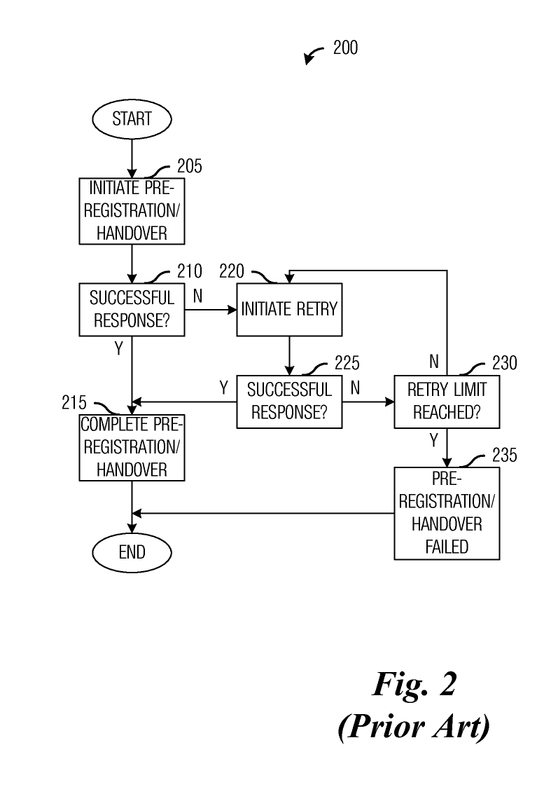

FIG. 2 illustrates a flow diagram of UE operations 200 in a prior art tunneling system error handling technique. Operations 200 may begin with a UE, via tunneling, initiating a pre-registration handover by transmitting a pre-registration procedure initialization message, a registration procedure initialization message, or a handover preparation procedure initialization message to a HRPD AN (block 205). If the UE receives a successful response (block 210), then the UE and the HRPD AN may continue to complete the pre-registration procedure, registration procedure, or the handover preparation procedure (block 215). Operations 200 may then terminate.

However, if the UE does not receive a successful response (or any response), the UE may initiate a retry attempt (block 220). The retry attempt may include the UE retransmitting another pre-registration procedure initialization message, registration procedure initialization message, or another handover preparation procedure initialization message to the HRPD AN.

If the UE receives a successful response to the retry attempt (block 225), then the UE and the HRPD AN may continue to complete the pre-registration procedure, registration procedure, or the handover preparation procedure (block 215). However, if the UE does not receive a successful response (or any response), the UE may check to determine if it has reached a retry attempt limit (block 230). If it has not reached the retry attempt limit, then the UE may repeat the retry attempt (block 220). If it has reached the retry attempt limit, then the pre-registration procedure, registration procedure, or the handover preparation procedure terminates as a failure (block 235). Operations 200 may then terminate.

While the long-term error condition associated with a system error may impact all UEs in the LTE communication system due to the re-send transmissions made by a subset of UEs, it may actually be an error in the HRPD communications system. While the system error remains to be resolved, a number of UEs in the LTE communications system are re-sending messages to initiate the pre-registration procedure, registration procedure, or the handover preparation procedure to LTE eNB, consuming control channel resources. The re-send messages may significantly downgrade the performance and throughput of the LTE communications system. If there are enough UEs re-sending messages, the re-send messages may potentially lead to a service outage in the LTE communications system. For example, a single UE may transmit N messages due to a single long-term error, where N is the retry attempt limit. If there is a large number of UEs, the resulting messages may overwhelm the LTE communications system, although the error condition is not in the LTE communications system.

Since the long-term error condition in the HRPD communications system impacts the performance of the LTE communications system, it may be possible to let the management entities (MMEs and/or eNBs) of the LTE communications system perform the tunneling system error handling rather than leaving the error handling to the UEs. The MMEs and/or eNBs may be better equipped to perform the error handling (when compared to the HRPD communications system) since the MMEs and/or eNBs and the UEs are both members of the LTE communications system. Additionally, the use of the MMEs and/or eNBs to perform error handling may be preferable to letting the individual UEs perform the error handling, such as described in the prior art error handling technique discussed in FIG. 2.

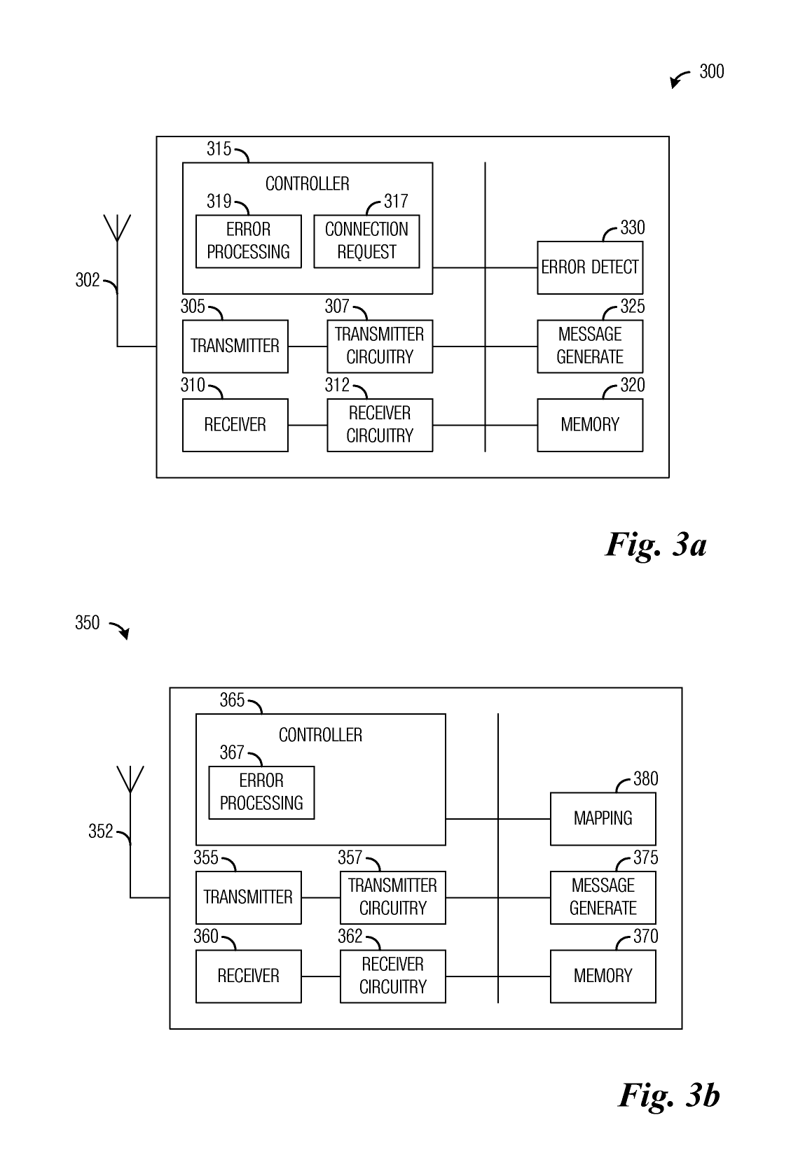

FIG. 3a illustrates an AN 300. AN 300 may be representative of a AN of a HRPD communications system. AN 300 may control access to the HRPD communications system, granting requests from communications devices for entry, such as through pre-registration, registration, initial entry, handover, or so forth.

AN 300 may have at least one antenna 302. Antenna 302 may serve as both a transmit antenna and a receive antenna. Alternatively, UE/AT 300 may have separate transmit and receive antennas. AN 300 may also have a wireline connection, such as a backhaul connection, to other network components, such as eNBs, base stations, MMEs, and so forth. Coupled to antenna 302 may be a transmitter 305 used to transmit information over the air using antenna 302. Transmitter circuitry 307 coupled to transmitter 305 may provide signal processing for information being transmitted. Examples of signal processing provided by transmitter circuitry 307 may include filtering, amplifying, modulating, error encoding, parallel-to-serial converting, interleaving, bit puncturing, and so forth.

Also coupled to antenna 302 may be a receiver 310 used to receive information detected by antenna 302. Receiver circuitry 312 coupled to receiver 310 may provide signal processing for received information. Examples of signal processing provided by receiver circuitry 312 may include filtering, amplifying, demodulating, error detecting and correcting, serial-to-parallel converting, de-interleaving, and so on. As used herein, transmitter 305 and receiver 310 may be a wireless transmitter and receiver as well as a wireline transmitter and receiver.

A controller 315 may be a processing unit responsible for executing applications and programs, controlling operations of various components of AN 300, processing and granting access requests from communications devices attempting to gain access to a communications system to which AN 300 is attached, and so forth. In addition to the above listed operations, controller 315 may be responsible for processing and propagating error information regarding the HRPD communications system of which AN 300 is a part. To support controller 315 in processing and propagating error information regarding the HRPD communications system, AN 300 includes a memory 320 and a message generate unit 325.

Memory 320 may be used to store information about errors detected in the HRPD communications system, such as error type, expected duration, and so forth. Also stored in memory 320 may be information related to communications devices granted access to the HRPD communications system, especially the ones impacted by the errors.

Message generate unit 325 may be used to generate error messages, where the error messages may be generated based on the error type, error duration, communications devices impacted by the error, cause code, and so on. Message generate unit 325 may generate error messages so that they may be transmitted as a separate independent message. According to an alternative embodiment, the error messages may be generated so that they are part of a message exchange occurring between AN 300 and a communications device participating in a pre-registration procedure, registration procedure, or a handover procedure with the HRPD communications system. According to another alternative embodiment, the error messages may be generated in such a way that they may be piggy-backed on other types of messages, including but not limited to acknowledgements (both positive and negative acknowledgements). According to yet another alternative embodiment, the error message may be generated so that the error information is in the form of an indicator to be contained in a message.

Controller 315 may include a connection request unit 317 that may be used to process requests from communications devices attempting to obtain access to the HRPD communications system. A communications device may attempt to obtain access to the communications system when they power on in a service area of the HRPD communications system. Additionally, a communications device may attempt to obtain access to the communications system through a handover procedure if the communications device attempting to get access, although the communications device already has service by way of a different communications system. For example, a communications device may already have network access through an LTE communications system may also request network access through the HRPD communications system if the HRPD communications system provides services not available in the LTE communications system. Connection request unit 317 may serve as an interface for the communications devices to authenticate, authorize, and other processing required to grant access to the communications devices.

Controller 315 may also include an error processing unit 319 that may be used to process and propagate error information related to errors detected in the HRPD communications system. Error processing unit 319 may determine error type (for example, short-term error or long-term error), expected duration of error, communications devices impacted by the error (if any), and so forth. Controller 315, through error processing unit 319, may propagate error information related to the detected error in order to reduce an impact of the error. For example, controller 315 may send messages to communications devices attempting to gain access to the HRPD communications system that a long-term error has occurred and that the communications devices should halt their attempts to gain entry to the communications system while the long-term error remains unresolved. By informing the communications devices (either by direct messaging, or by informing network elements that control the communications devices, such as MMEs, eNBs, base stations, or so on), the controller 315 may reduce the impact of the error on the communications devices and their associated communications systems. However, to ensure that information related to errors is provided to all communications devices, it may be preferred that AN 300 propagates information related to all types of errors to other communications systems.

AN 300 also includes an error detect unit 330. Error detect unit 330 may be used to detect the occurrence of an error in the HRPD communications system. Furthermore, error detect unit 330 may provide information related to the detected error, such as error type, expected duration, and so forth.

FIG. 3b illustrates a MME 350. MME 350 may be representative of a MME of a LTE communications system. MME 350 may be used to control pre-registration requests, registration requests, handover preparation, and so forth. In general, a MME may also function as an eNB. In an interworking between two communications systems, a MME may be an eNB with connectivity to both communications systems. Therefore, the MME may be referred to as an edge node.

MME 350 may have at least one antenna 352. Antenna 352 may serve as both a transmit antenna and a receive antenna. Alternatively, MME 350 may have separate transmit and receive antennas. MME 350 may also have a wireline connection, such as a backhaul connection, to other network components, such as eNBs, base stations, ANs, and so forth. Coupled to antenna 352 may be a transmitter 355 used to transmit information over the air using antenna 352. Transmitter circuitry 357 coupled to transmitter 355 may provide signal processing for information being transmitted. Examples of signal processing provided by transmitter circuitry 357 may include filtering, amplifying, modulating, error encoding, parallel-to-serial converting, interleaving, bit puncturing, and so forth.

Also coupled to antenna 352 may be a receiver 360 used to receive information detected by antenna 352. Receiver circuitry 362 coupled to receiver 360 may provide signal processing for received information. Examples of signal processing provided by receiver circuitry 362 may include filtering, amplifying, demodulating, error detecting and correcting, serial-to-parallel converting, de-interleaving, and so on. As used herein, transmitter 305 and receiver 310 may be a wireless transmitter and receiver as well as a wireline transmitter and receiver.

A controller 365 may be a processing unit responsible for executing applications and programs, controlling operations of various components of MME 350, processing and granting access requests from communications devices attempting to gain access to an external communications system, and so forth. In addition to the above listed operations, controller 365 may be responsible for processing and propagating error information regarding the external communications system attached to MME 350, where the error information may be provided to MME 350 by a AN of the external communications system. To support controller 365 in processing and propagating error information regarding the communications system, MME 350 includes a memory 370 and a message generate unit 375.

Memory 370 may be used to store information about errors detected in the external communications system, such as error type, expected duration, and so forth. Also stored in memory 370 may be information related to communications devices granted access to the external communications system, especially the ones impacted by the errors. Message generate unit 375 may be used to generate error messages, where the error messages may be generated based on the error type, error duration, communications devices impacted by the error, and so on.

MME 350 also includes a mapping unit 380 that may be used to maintain a mapping between eNBs (and MMEs) and HRPD ANs. For example, mapping unit 380 may maintain mapping information of eNBs with UEs with connections to a HRPD AN. Mapping unit 380 may have a different map for each HRPD AN if there are more than one HRPD ANs. Furthermore, a single eNB may have UEs with connections to different HRPD ANs, therefore, the single eNB may appear in multiple mappings.

Controller 365 may include an error processing unit 367 that may be used to process and propagate error information related to errors detected in the external communications system (e.g., the HRPD communications system) and received from an AN of the external communications system. Error processing unit 367 may determine error type (for example, short-term error or long-term error), expected duration of error, communications devices impacted by the error (if any), and so forth. Error processing unit 367 may determine error type by examining the error information from the AN. For example, error processing unit 367 may examine a cause code contained in the error information from the AN.

Controller 365, through error processing unit 367, may propagate error information related to the detected error in order to reduce an impact of the error. For example, controller 365 may send messages to eNBs of UEs attempting to gain access to the HRPD communications system and that the eNBs should halt the attempts of the communications devices to gain entry to the HRPD communications system while the long-term error remains unresolved.

Error processing unit 367 may determine which eNBs should receive the error information received from the AN. Error processing unit 367 may make use of mapping information contained in mapping unit 380, for example. Controller 365, through error processing unit 367, may propagate error information related to the detected error in order to reduce an impact of the error if the detected error is a long-term error. However, if the detected error is a short-term error, controller 365 may elect to not propagate the error information. For example, controller 365 may send messages to the eNBs of the UEs attempting to gain access to the HRPD communications system where a long-term error has occurred and that the eNBs should halt the attempts of the UEs to gain entry to the HRPD communications system while the long-term error remains unresolved. By informing the UEs (either by direct messaging, or by informing network elements that control the UEs, such as MMEs, eNBs, base stations, or so on), the controller 365 may reduce the impact of the error on the UEs and their associated communications systems.

Preferably, the propagation of the error information may occur during a handover procedure involving a communications device served by the MME, a pre-registration procedure involving the communications device, a registration procedure involving the communications device, a message exchange involved in maintenance messages involving the communications device, or a combination thereof.

Although the discussion focuses on a MME determining whether or not to propagate the error information based on the error type, it may be possible that an eNB serving affected UEs may determine whether or not to propagate the error information based on the error type. Therefore, the discussion of a MME determining whether or not to propagate the error information based on the error type should not be construed as being limiting to either the scope or the spirit of the embodiments.

If the eNBs are responsible for determining whether or not to propagate the error information, the eNB may not need to know the mapping between eNB (and MMEs) and HRPD ANs since the eNB knows the identities of the UEs that it is serving and if they have active connections (or are trying to establish a connection) to the AN's HRPD communications system.

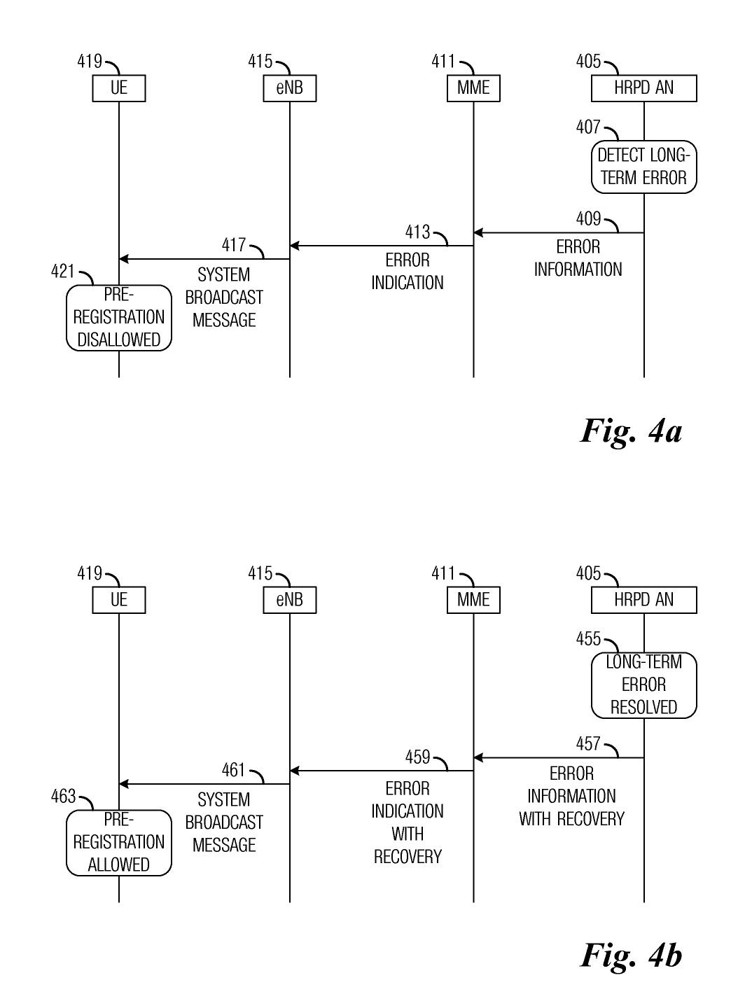

FIG. 4a illustrates a transmission flow diagram for messages exchanged after a long-term error has been detected in an interworking with an LTE communications system and a HRPD communications system. The message exchange may begin with a HRPD AN 305 detecting a long-term error condition (block 407). As discussed previously, a long-term error condition may include System Failures or Path Failures. According to an embodiment, HRPD AN 405 may initially detect an occurrence of an error of an unknown type. Then, through error detection techniques that may be beyond the scope of the present discussion, determine the nature of the error, i.e., a short-term error or a long-term error.

Regardless of error type, HRPD AN 405 may transmit information related to the error (shown as message 409) to a MME 411 of the LTE communications system. Message 409 may be a notification of a system error and may be made through S101. Message 409 may be a S101 Notification Request message that includes an additional field “Cause Code.” The Cause Code field may convey an indication of the type of the error condition that has been detected. According to an alternative embodiment, information related to the error may be transmitted to MME 411 in the form of an error message. According to another alternative embodiment, information related to the error may be transmitted to MME 411 by piggy-backing the information on a transmission to MME 411. For example, information related to the error may be piggy-backed onto an acknowledgement (positive or negative) transmitted to MME 411. According to yet another embodiment, information related to the error may be in the form of an indicator that may be included in a message being transmitted to MME 411.

After MME 411 receives the information related to the error (e.g., a S101 Notification Request message) from HRPD AN 405, MME 411 may determine the error type, i.e., either a long-term error or a short-term error. The behavior of MME 411 may differ based on error type. For example, if the error is a short-term error, MME 411 may elect to not propagate the error information. However, if the error is a long-term error, MME 411 may elect to propagate the error information by taking action that may reduce an impact of the error on the LTE communications system.

According to an embodiment, MME 411 may transmit an error indication 413 to an eNB 415. Error indication 413 may be an “Error Indication” message, containing a Cause Code indicating a HRPD system permanent failure. Error indication 413 may also be piggy-backed on some other transmission sent to eNB 415, or an indicator included in another transmission sent to eNB 415, and so forth.

Since MME 411 maintains a mapping table between related eNBs and HRPD AN 405, MME 411 may be able to determine the eNBs to which it will transmit error indication 413. For example, MME 411 may utilize a sector ID of HRPD AN 405 to determine that eNB 415 should receive error indication 413.

After eNB 415 receives error indication 413 from MME 411, eNB 415 may alter its operation. For example, eNB 415 may change a pre-registration bit in a system broadcast message (SIB8) 417 to “disallow,” which will disable all HRPD pre-registrations, registrations, and so forth, throughout a cell served by eNB 415. System broadcast message 417 may be received at UE 419. System broadcast message 417 may effectively stop all retry-attempts by UEs, such as UE 419. Additionally, if there are UEs already in a handover procedure with HRPD AN 405, eNB 415 may either stop the handover procedure (since the target HRPD communications system is down) or it may switch the handover procedure from an optimized handover to a non-optimized handover and let the UE find its own suitable HRPD communications system.

At UE 419, after receiving system broadcast message 417, pre-registration procedures are blocked (block 421). Similarly, if UE 419 was in a handover procedure, the handover procedure may also be disabled or UE 419 may be forced to find a suitable HRPD communications system to perform a handover with on its own, i.e., a different HRPD communications system that may not be faulty.

FIG. 4b illustrates a transmission flow diagram for messages exchanged after a long-term error has been resolved. After a long-term error condition has been resolved (block 455), HRPD AN 405 may transmit information related to the error with recovery (shown as message 457) to MME 411 of the LTE communications system. According to an embodiment, message 457 may be a notification of the resolution of a system error and may be made through S101. Message 457 may be a S101 Notification Request message with a Recovery field set, which may be indicative of the resolution of the long-term error condition. According to an alternative embodiment, information related to the error with recovery may be transmitted to MME 411 in the form of an error message. According to another alternative embodiment, information related to the error with recovery may be transmitted to MME 411 by piggy-backing the information on a transmission to MME 411. For example, information related to the error with recovery may be piggy-backed onto an acknowledgement (positive or negative) transmitted to MME 411. According to yet another embodiment, information related to the error with recovery may be in the form of an indicator that may be included in a message being transmitted to MME 411.

Upon receipt of message 457, MME 411 may transmit an error indication with recovery 459 to eNB 415. As an example, error indication with recovery 459 may be an “Error Indication” message and may contain recovery information and a sector ID associated with the HRPD communications network. Alternatively, MME 411 may use a control message to convey the recovery information. Error indication with recovery 413 may also be piggy-backed on some other transmission sent to eNB 415, or an indicator included in another transmission sent to eNB 415, and so forth. eNB 415 may then restore HRPD pre-registration procedures by transmitting a system broadcast message 461 with a pre-registration bit to “allow,” for example. System broadcast message 461 may enable all HRPD pre-registrations throughput a cell served by eNB 415. Furthermore, eNB 415 may once again conduct optimized handover preparation procedures for UEs in need of handovers.

At UE 419, after receiving system broadcast message 461, pre-registration procedures are allowed (block 463). Similarly, optimized handover preparation procedures are again supported by eNB 415.

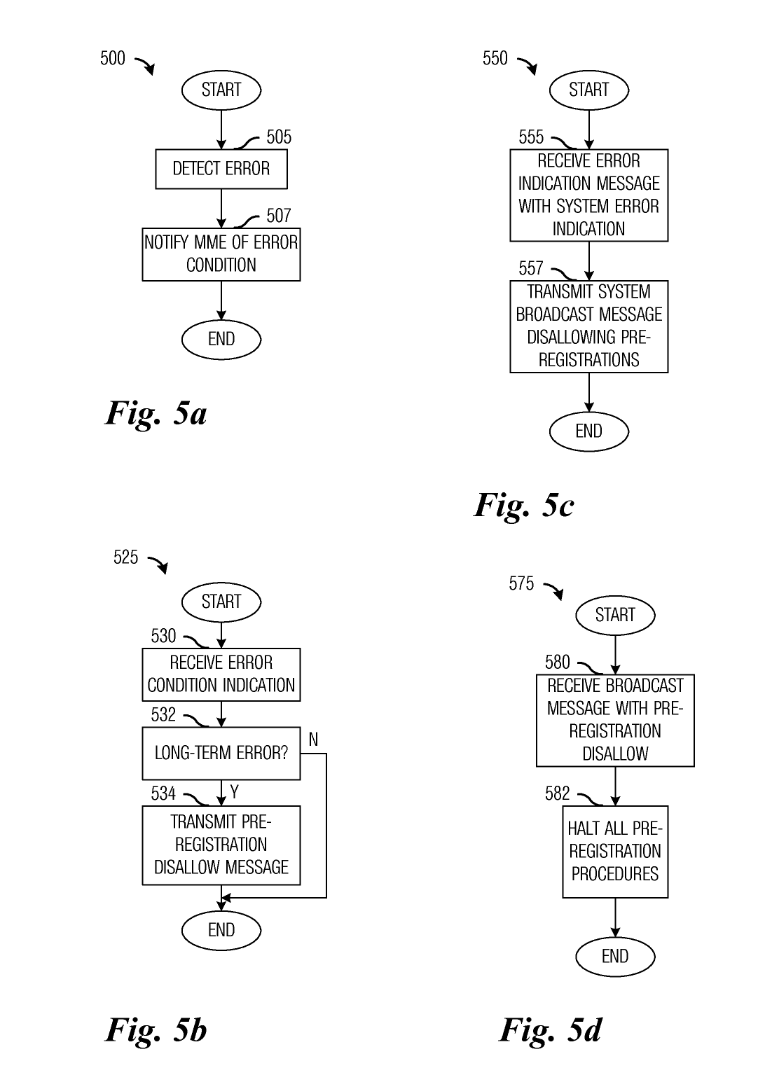

FIG. 5a illustrates a flow diagram of HRPD AN operations 500 in system error handling. HRPD AN operations 500 may be indicative of operations occurring in a HRPD AN of a HRPD communications system as the HRPD AN detects an occurrence of an error in the HRPD communications system. HRPD AN operations 500 may occur while the HRPD AN and the HRPD communications system are in a normal operating mode.

HRPD AN operations 500 may begin when the HRPD AN detects that an error, either a short-term error or a long-term error (block 505). The HRPD AN may propagate information related to the error to other communications devices (block 507).

The propagation of the information related to the error may cause UEs with active connections to the HRPD communications system and that are affected by the error to stop any pre-registration procedures, registration procedures or handover preparation procedure. The UEs with active connections to the HRPD communications system may not all be in a service area of the HRPD communications system. For example, UEs in a service area of an LTE communications system may have an active connection to the HRPD communications system and may be affected by the long-term error. The HRPD AN may do so by notifying a MME of the error condition (block 509). As discussed previously, the HRPD AN may notify the MME with a S101 Notification Request message that includes an additional field “Cause Code.” The Cause Code field may convey an indication of the type of long-term error condition that has been detected.

According to an alternative embodiment, information related to the error may be transmitted to the MME in the form of an error message. According to another alternative embodiment, information related to the error may be transmitted to the MME by piggy-backing the information on a transmission to the MME. For example, information related to the error may be piggy-backed onto an acknowledgement (positive or negative) transmitted to the MME. According to yet another embodiment, information related to the error may be in the form of an indicator that may be included in a message being transmitted to the MME. HRPD AN operations 500 may then terminate.

FIG. 5b illustrates a flow diagram of MME operations 525 in system error handling. MME operations 525 may be indicative of operations occurring in a MME of serving in an interworking with two communications systems, such as with a LTE communications system and a HRPD communications system, and a long-term error occurs in one of the two communications systems. MME operations 525 may occur while the MME and the two communications systems are in a normal operating mode.

MME operations 525 may begin with the MME receiving a message from the HRPD indicating that an error has occurred in the HRPD communications system (block 530). Based on the type of the error, i.e., long-term error or short-term error, the MME may elect to either propagate the error information or not.

If the error type is a short-term error (block 532), the MME may elect to not propagate the error information. If the error type is a long-term error (block 532), the MME may cause UEs with active connections to the HRPD communications system and that are affected by the long-term error to stop any pre-registration procedures, registration procedures, or handover preparation procedure. The MME may do so by notifying an eNB of the error condition (block 534). For example, the MME may transmit an error indication message to affected eNBs. As discussed previously, since the MME maintains a mapping table between related eNBs and the HRPD AN, the MME may be able to determine the eNBs to which it will transmit the error indication message. For example, the MME may utilize a sector ID of the HRPD AN to determine which eNBs should receive the error indication message.

According to an alternative embodiment, an error indication may also be piggy-backed on some other transmission sent to the eNBs, or an indicator included in another transmission sent to the eNBs, and so forth. MME operations 525 may then terminate.

According to another alternative embodiment, the MME may decide to not determine the error type. Instead, the MME may simply propagate the information related to the error to eNBs and let the eNBs decide to determine the error type and propagate the error information based on the error type.

FIG. 5c illustrates a flow diagram of eNB operations 550 in system error handling. eNB operations 550 may be indicative of operations occurring in an eNB of a LTE communications system containing UEs with active connections to a HRPD communications system. eNB operations 550 may occur while the eNB is in a normal operating mode.

eNB operations 550 may begin with the eNB receiving a message from the MME indicating that a long-term error has occurred in the HRPD communications system (block 555). The eNB may then cause UEs with active connections to the HRPD communications system and are affected by the long-term error to stop any pre-registration procedures, registration procedures, or handover preparation procedure. The eNB may do so by notifying UEs that pre-registration procedures (as well as registration procedures and handover preparation procedures) are disallowed (block 557). For example, the eNB may transmit a system broadcast message (SIB8) with a pre-registration bit set to disallow. The system broadcast message may effectively stop all retry-attempts by UEs, such as UE 419 of FIG. 4a. Additionally, if there are UEs already in a handover procedure with the HRPD AN, the eNB may either stop the handover procedure (since the target HRPD communications system is down) or switch the handover procedure from an optimized handover to a non-optimized handover and lets the UE find its own suitable HRPD communications system. eNB operations 550 may then terminate.

According to an alternative embodiment, it may be possible that the MME simply forwarded the information related to the error to the eNB. The eNB may then need to determine the error type, i.e., either long-term error or short-term error. If the error is a short-term error, then the eNB may elect to not propagate the error information. If the error is a long-term error, then the eNB may cause UEs with active connections to the HRPD communications system and are affected by the long-term error to stop any pre-registration procedures, registration procedures, or handover preparation procedure as discussed above. Furthermore, the eNB may disallow the UEs from interworking functions by broadcast or unicast an error indication. For example, the eNB may transmit a message containing a pre-registration allow/disallow bit. Additionally, the eNB may simply reject any interworking requests from the UEs. If the error is a short-term error, the eNB may elect to not propagate the information related to the error, instead choosing to do nothing.

FIG. 5d illustrates a flow diagram of UE operations 575 in system error handling. UE operations 575 may be indicative of operations occurring in a UE that is operating in a LTE communications system but has (or is trying to establish) an active connection to a HRPD communications system. UE operations 575 may occur while the UE is in a normal operating mode.

UE operations 575 may begin with the UE receiving the system broadcast message transmitted by the eNB with the pre-registration bit set to disallow (block 580). Alternatively, rather than receiving a system broadcast message from the eNB, the UE may receive a message specifically addressed to the UE, where the message contains an indicator that disallows pre-registration or registration with the HRPD communications system. The UE may then discontinue any active pre-registration procedures as well as stop any planned pre-registration procedures or registration procedures (block 582). Additionally, if the UE is in a handover preparation procedure or about to start a handover preparation procedure, the UE may have to stop. Alternatively, the UE may find a suitable HRPD communications system with which it may perform a handover preparation procedure on its own. UE operations 575 may then terminate.

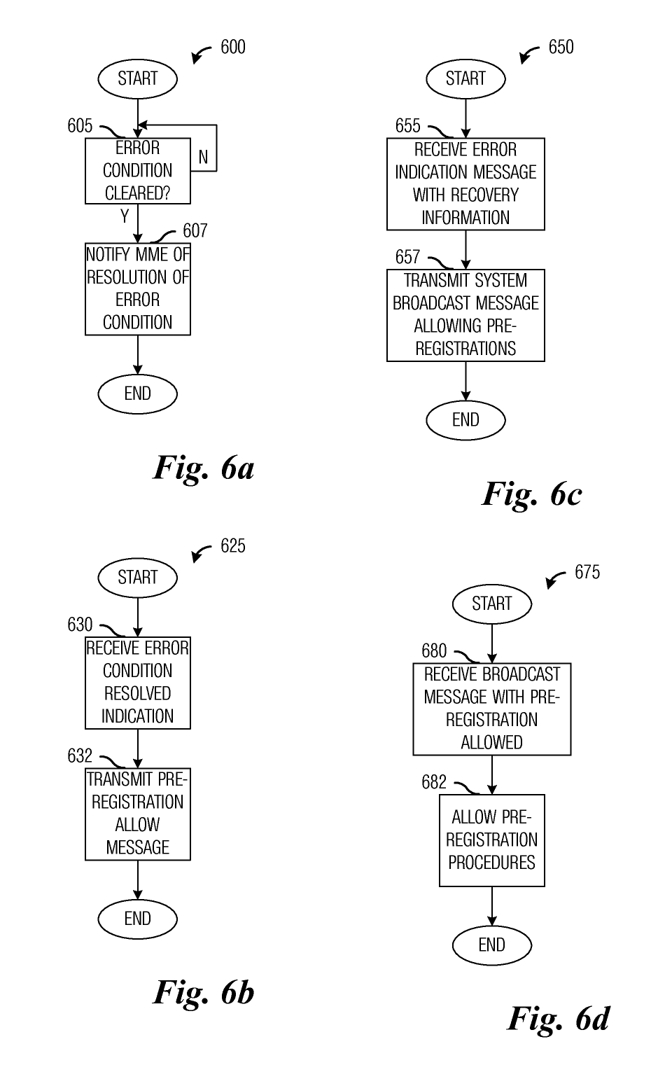

FIG. 6a illustrates a flow diagram of HRPD AN operations 600 in system error handling after system error recovery. HRPD AN operations 600 may be indicative of operations occurring in a HRPD AN of a HRPD communications system as the HRPD AN detects an occurrence of an error in the HRPD communications system. HRPD AN operations 600 may occur while the HRPD AN and the HRPD communications system are in a normal operating mode.

HRPD AN operations 600 may begin when the HRPD AN detects that an error (e.g., a short-term error or a long-term error, such as a System Failure or a Path Failure) has been resolved (block 605). The HRPD AN may then allow UEs with active connections to the HRPD communications system or those desiring to establish connections to initiate pre-registration procedures, registration procedures, or handover preparation procedures. As discussed previously, the HRPD AN may notify the MME of the error condition resolution (block 607). As discussed previously, the HRPD AN may notify the MME with a S101 Notification Request message with a recovery field set to indicate that the long-term error has been resolved.

According to an alternative embodiment, information related to the error resolution may be transmitted to the MME in the form of an error resolution message. According to another alternative embodiment, information related to the error resolution may be transmitted to the MME by piggy-backing the information on a transmission to the MME. For example, information related to the error resolution may be piggy-backed onto an acknowledgement (positive or negative) transmitted to the MME. According to yet another embodiment, information related to the error resolution may be in the form of an indicator that may be included in a message being transmitted to the MME. HRPD AN operations 600 may then terminate.

FIG. 6b illustrates a flow diagram of MME operations 625 in system error handling after system error recovery. MME operations 625 may be indicative of operations occurring in a MME of serving in an interworking with two communications systems, such as with a LTE communications system and a HRPD communications system, and a resolution of a long-term error has occurred. MME operations 625 may occur while the MME and the two communications systems are in a normal operating mode.

MME operations 625 may begin with the MME receiving a message from the HRPD AN indicating that the long-term error in the HRPD communications system has been resolved (block 630). The message may include a recovery field set to a value to indicate that the long-term error has been resolved. According to an alternative embodiment, information related to the error with recovery may be transmitted to the MME in the form of an error message. According to another alternative embodiment, information related to the error with recovery may be transmitted to the MME by piggy-backing the information on a transmission to the MME. For example, information related to the error with recovery may be piggy-backed onto an acknowledgement (positive or negative) transmitted to the MME. According to yet another embodiment, information related to the error with recovery may be in the form of an indicator that may be included in a message being transmitted to the MME.

The MME may then allow UEs with active connections to the HRPD communications system or those desiring to establish connections to initiate pre-registration procedures, registration procedures, or handover preparation procedures. The MME may do so by notifying an eNB of the resolution of the error condition (block 632). The MME may transmit an error indication message with recovery information and sector ID associated with the HRPD communications system to affected eNBs. Alternatively, the MME may convey the recovery information using control messages. MME operations 625 may then terminate.

FIG. 6c illustrates a flow diagram of eNB operations 650 in system error handling after system error recovery. eNB operations 650 may be indicative of operations occurring in an eNB of a LTE communications system containing UEs with active connections to a HRPD communications system. eNB operations 650 may occur while the eNB is in a normal operating mode.

eNB operations 650 may begin with the eNB receiving an error indication message from the MME indicating the resolution of the long-term error (block 655). The eNB may then allow UEs with active connections to the HRPD communications system or those desiring to establish connections to initiate pre-registration procedures or handover preparation procedures. The eNB may do so by notifying UEs that pre-registration procedures (and registration procedures or handover preparation procedures) are allowed (block 657). For example, the eNB may transmit a system broadcast message (SIB8) with a pre-registration bit set to allow. The system broadcast message may effectively enable all retry-attempts by UEs, such as UE 419 of FIG. 4a, as well as any future pre-registration procedure, registration procedures, and handover preparation procedure attempts. eNB operations 650 may then terminate.

FIG. 6d illustrates a flow diagram of UE operations 675 in system error handling after system error recovery. UE operations 675 may be indicative of operations occurring in a UE that is operating in a LTE communications system but has (or is trying to establish) an active connection to a HRPD communications system. UE operations 675 may occur while the UE is in a normal operating mode.

UE operations 675 may begin with the UE receiving the system broadcast message transmitted by the eNB with the pre-registration bit set to allow (block 680). The UE may then restart any active pre-registration or registration procedures as well as proceed with any planned pre-registration procedures or registration procedures (block 682). Additionally, if the UE is in a handover preparation procedure or about to start a handover preparation procedure, the UE may be able to restart those with assistance of the eNB. UE operations 675 may then terminate.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method for error handling by a controller in an interworking system, the method comprising:
receiving a notification of an occurrence of an error in a first communications system;
determining if the error is a long-term error; and
causing a device in a second communications system with a session in the first communications system to halt communications with the first communications system if the error is a long-term error, wherein device in the second communications system with the session in the first communications system is not caused to halt communications with the first communications system if the error is not a long-term error.

2. The method of claim 1, wherein the notification is sent by an access node of the first communications system.

3. The method of claim 1, wherein causing a device in a second communications system comprises transmitting a message to a communications controller of the device, the message comprising an indication of the error.

4. The method of claim 3, wherein the message comprises a cause code field, where the cause code field indicates a nature of the error.

5. The method of claim 3, wherein the message is a part of a message exchange occurring in a handover procedure with the device in the second communications system, wherein the handover procedure is used to establish a session between a device in the second communications system with the first communications system.

6. The method of claim 3, wherein the message is part of a message exchange during a handover procedure with the device in the second communications system, a message exchange during a pre-registration procedure of the device, a message exchange during a registration procedure, a message exchange in maintenance communications, or a combination thereof.

7. The method of claim 1, wherein causing a device in second communications system comprises combining an indication of the error to a message being transmitted to a communications controller.

8. The method of claim 7, wherein the indication is piggy-backed on an acknowledgement transmitted by the controller.

9. The method of claim 1, wherein determining if the error is a long-term error comprises determining if the error is a failure in the first communications system or a failure of a path in the first communications system.

10. The method of claim 9, wherein determining if the error is a long-term error comprises reading a cause code in the notification.

11. The method of claim 1, wherein the first communications system is a high rate packet data (HRPD) compliant communications system, and the second communications system is a Third Generation Partnership Project Long Term Evolution compliant communications system.

12. The method of claim 1, wherein causing a device in a second communications system comprises transmitting a message to the device, the message comprising an indication of the error.

13. A method for error handling in an interworking system, the method comprising:
receiving error information indicating that a long-term error has occurred in a first communications system, the error information received by a management controller of a second communications system; and
causing a device in the second communications system with a connection to the first communications system to halt communications with the first communications system in response to the error information.

14. The method of claim 13, wherein the error information is received in the form of an error message, an indicator combined with a message, an indicator piggy-backed on an acknowledgement, or a combination thereof.

15. The method of claim 13, wherein causing a device in a second communications system comprises sending a message to a base station serving the device, the message comprising an error indication indicating that the base station halt communications from the device to the first communications system.

16. The method of claim 15, wherein there is a plurality of devices in the second communications system with a connection to the first communications system, and wherein causing a device in a second communications system further comprises repeating sending a message for each device in the plurality of devices, the message comprising the error indication.

17. The method of claim 13, wherein causing a device in a second communications system comprises sending a message to the device, the message comprising an error indication indicating that the device to halt communications to the first communications system.

18. A management controller comprising:
a receiver to be coupled to a receive antenna for receiving signals detected by the receive antenna;
a transmitter to be coupled to a transmit antenna for transmitting signals with the transmit antenna;
a controller coupled to the receiver and to the transmitter, the controller configured to propagate error information related to an error detected in a first communications system to a device in a second communications system having a connection to the first communications system;
a mapping unit coupled to the controller, the mapping unit configured to maintain a mapping of the device to a controller in the second communications system serving the device; and
a message generate unit coupled to the controller, and to the transmitter, the message generate unit configured to generate an error information message to be propagated to the device desiring to establish the connection with the first communications system.

19. The management controller of claim 18, wherein the controller comprises an error processing unit coupled to the mapping unit, the error processing unit configured to propagate the error information to the device based on the mapping maintained by the mapping unit and an error type of the error.

20. The management controller of claim 19, wherein there is a plurality of devices desiring to establish a plurality of connections to the first communications system, wherein there is a mapping maintained by the mapping unit for each device, and wherein the error processing unit is further configured to propagate the error information to each device in the plurality of devices based on the mapping for each device.

21. The management controller of claim 18, wherein the error information message is an error indication message with an indicator indicating a failure in the first communications system.
